(19) United States
(12) Patent Application Publication
(10) Pub. No.: US 2005/0137273 A1
(43) Pub. Date: Jun. 23, 2005

(54) Process for the production of polyurethane integral skin foams

(75) Inventors: Norbert Eisen, Koln (DE); Hans-Detlef Arntz, Lohmar (DE); Lutz Liebegott, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/008,592

(22) Filed: Dec. 9, 2004

(30) Foreign Application Priority Data
Dec. 17, 2003 (DE) 10359075.7

(51) Int. Cl. C08J 9/34

(52) U.S. Cl. 521/51

(57) ABSTRACT

Polyurethane articles having a compressed shell and a cellular core, so-called integral skin foams are produced from an isocyanate component which includes one or more inorganic zeolites.

### BACKGROUND OF THE INVENTION

The present invention relates to a process for the production of molded polyurethane articles having a compressed shell and a cellular core, so-called integral skin foams, using inorganic zeolites.

For the production of polyurethane moldings having a compressed shell and a cellular internal structure, monofluorotrichloromethane (R11) was used almost exclusively as the blowing agent until its ozone-damaging behavior became known. Along with these findings, a large number of other fluorine-containing blowing gases of the hydrochlorofluorocarbon (HCFC) and fluorohydrocarbon (HFC) type were developed and studied. Hydrocarbons were also involved in these studies, as is evident from the literature (DE-A 3 430 285; U.S. Pat. No. 3,178,490; U.S. Pat. No. 3,182,104; U.S. Pat. No. 4,065,410; DE-A 2 622 957; U.S. Pat. No. 3,931,106 and DE-A 2 544 560).

Typical representatives of HFC's are R365mfc (1,1,1,3,3-pentafluorobutane) and R245fa (1,1,1,3,3-pentafluoropropane), and typical representatives of hydrocarbons are n-pentane, isopentane, cyclopentane and isohexane. Ketones (e.g., acetone) or ethers may also be used as blowing agents. The mentioned blowing agents are suitable for producing integral skin foams having a pronounced shell. However, mixtures of the mentioned blowing agents and polyol formulations or isocyanates, which are conventionally manufactured for further processing to molded bodies, generally have flash points at very low temperatures, so that so-called explosion protection is required for the processing machines.

In DE-A 1 804 362, alkali aluminum silicates are used in addition to fluorochlorohydrocarbons to produce PUR foams which are less susceptible to shrinkage.

EP-A 319 866 describes a process for the production of polyurethane moldings having an apparent density of at least 300 kg/m³, in which zeolitic adsorbents are employed with the use of water and/or carbon dioxide. The zeolites are added to the polyol formulation.

### SUMMARY OF THE INVENTION

The object of the invention is to provide a process for the production of soft to rigid polyurethane molded articles having a compressed shell and a cellular core without the use of physical blowing agents, which process can be carried out without explosion protection measures.

Surprisingly, it has been found that the integral structure of the moldings, the foaming process and the quality of the moldings could be greatly improved in comparison with EP-A 319 866 by using inorganic zeolites in the isocyanate component.

### DETAILED DESCRIPTION OF THE INVENTION

The present invention provides a process for the production of polyurethane integral skin foams in which a polyol formulation (A) comprising
a) at least one polyol component having an OH number of from 20 to 1050, preferably from 200 to 900, and a functionality of from 2 to 6, preferably from 2 to 5, or a mixture of polyol components having a mathematically ascertained mean OH number of from 250 to 650, preferably from 350 to 500, and a mathematically ascertained mean functionality of from 2.5 to 5, preferably from 3 to 4.5,
b) optionally, one or more chain extenders and/or crosslinkers,
c) optionally, one or more activators,
d) water and
e) optionally, one or more additives and auxiliary substances known to those skilled in the art
   is reacted with an isocyanate component (B) comprising
f) one or more organic and/or modified organic polyisocyanates and/or polyisocyanate pre-polymers and
g) one or more inorganic zeolites.

Compared with the prior art, the molded articles produced by the process of the present invention have a higher surface hardness, which is indicative of an improved integral structure, and also a more favorable apparent density distribution, which is achieved as a result of better flow behavior in the mold.

The polyisocyanate f) may be any of the known aromatic polyisocyanates having a NCO content of at least 20 wt. %. Very particular preference is given to the use of the known polyisocyanate mixtures of the diphenylmethane group, as are obtainable, for example, by phosgenation of aniline/formaldehyde condensation products. These polyisocyanate mixtures, which are particularly suitable for the process according to the invention, generally have a content of diisocyanatodiphenylmethane isomers of from 50 to 100 wt. %, with the remainder being higher-functional homologues of these diisocyanates. The diisocyanates present in these mixtures are 4,4′-diisocyanatodiphenylmethane in admixture with up to 60 wt. %, based on the total amount of diisocyanates, of 2,4′-diisocyanatodiphenylmethane and, optionally, small amounts of 2,2′-diisocyanatodiphenylmethane. Urethane-, carbodiimide- or allophanate-modified derivatives of these polyisocyanates may also be used as the polyisocyanate f).

The polyhydroxyl component a) is at least one organic polyhydroxyl compound, preferably a mixture of several organic polyhydroxyl compounds, having a (mean) hydroxyl functionality of from 2.5 to 5, preferably from 3.0 to 4.5, and a (mean) hydroxyl number of from 250 to 650 mg KOH/g, preferably from 350 to 500 mg KOH/g. The individual constituents of the polyhydroxyl component a) are preferably polyether polyols which are known to those skilled in the art, such as those which can be obtained by alkoxylation of suitable starter molecules. Examples of suitable starter molecules are water, propylene glycol, ethylene glycol, glycerol, trimethylolpropane, sucrose, sorbitol, ethylenediamine and mixtures of such starter molecules. Suitable alkoxylating agents are especially propylene oxide and optionally ethylene oxide, which may be used either in admixture with propylene oxide or separately in separate reaction steps during the alkoxylation reaction.

In addition to such polyether polyols, the polyhydroxyl component a) may also comprise simple alkane polyols, such as ethylene glycol, propylene glycol, trimethylolpropane and/or glycerol, as a component of the mixture. The conventional polyester polyols of the prior art may also be constituents of component a), provided they satisfy the above-mentioned conditions.

The polyol component a) is often used in a form laden with air. A load of up to 35 vol. % air, based on atmospheric pressure, is usual.

Water is used as the blowing agent. The total amount of water introduced into the polyol formulation (A) is from 0.5 to 5 wt. %, preferably from 1 to 2 wt. %, based on the weight of the polyol formulation (A).

The activators c) that may optionally be used include the known tertiary amines that accelerate the isocyanate polyaddition reaction, such as triethylenediamine, N,N-dimethylaniline or N,N-dimethylcyclohexylamine, or organometallic compounds, especially tin compounds, such as tin(II) octoate or dibutyltin dilaurate. Trimerization catalysts, such as alkali acetates (e.g., sodium or potassium acetate), alkali phenolates such as sodium phenolate or sodium trichlorophenolate, or 2,4,6-tris(dimethylaminomethyl)-phenol, may also be used in the practice of the present invention.

Suitable chain extenders/crosslinkers include any of the conventional known compounds having OH or NH numbers of from 600 to 1850 mg KOH/g, preferably from 1050 to 1850 mg KOH/g, and having functionalities of from 2 to 4.

Auxiliary substances that are important for the invention are inorganic zeolites, i.e., alkali aluminosilicates or alkali-alkaline earth aluminosilicates. Synthetic zeolites are particularly suitable (see Ullmanns Enzyklopadie der technischen Chemie, 4th edition, Volume 17, pages 9-18, Verlag Chemie, Weinheim/New York).

The zeolites are generally used in the form of powders having a maximum particle diameter of 100 μm, preferably <10 μm.

Particularly suitable for the process according to the invention are synthetic zeolites of the faujasite type of the general formula
(M′M″_{1/2})O.Al₂O₃.ySiO₂.zH₂O
in which
M′ represents a sodium or potassium cation,
M″ represents a calcium or magnesium cation,
y has a value of from 2 to 6, synthetic zeolites of type X having a y value of from 2 to 3, those of type Y having a y value of from 3 to 6, and
z represents 0 or a number up to 5.5 (type X) or a number up to 8 (type Y).

The zeolite which is commercially available under the name Baylithe L from UOP, is particularly suitable.

The inorganic zeolites are preferably used in amounts of from 2 to 10 wt. %, particularly preferably from 3 to 5 wt. %, based on the polyisocyanate component (B).

Other auxiliary substances and additives may also be used concomitantly in the process according to the invention, whereas these additional substances are preferably added to the polyol formulation (“component A”). These include, for example, foam stabilizers, such as those based on polyether-modified polysiloxanes, flameproofing agents, stabilizers, internal mold-release agents and the like.

The polyurethane integral skin foams produced in accordance with the present invention preferably have an apparent density of from 100 to 500 kg/m³, most preferably from 180 to 400 kg/m³.

The process of the present invention is generally carried out by mixing components a) to e) and then combining the polyol mixture (A) with the polyisocyanate component (B). The last-mentioned mixing operation is carried out, for example, using agitator mixers or, preferably, using conventional high-pressure mixing units, as are conventionally employed in the production of polyurethane foams. After the reaction mixture has been prepared, it is introduced into the mold. In general, the temperature of the molding tool used is at least 30° C., preferably at least 50° C. The internal walls of the mold may, if required, be treated with any of the known external mold-release agents before filling.

The invention is explained in greater detail by means of the following Examples.

### EXAMPLES

### Example 1 (Comparison)

Formulation for rigid PUR foam:

Component A:

| | |
|---|---|
| 45.0 parts by weight | sucrose, propylene glycol-started polyether having a |
| | molecular weight of 600 g/mol. (OH number: 450) |
| | based on 1,2-propylene oxide |
| 35.0 parts by weight | sucrose, ethylene glycol-started polyether having a |
| | molecular weight of 360 g/mol. (OH number: 440) |
| | based on 1,2-propylene oxide |
| 15.0 parts by weight | trimethylolpropane-started polyether having a |
| | molecular weight of 160 g/mol. (OH number: 1030) |
| | based on 1,2-propylene oxide |
| 1 part by weight | stabilizer B 8411 (Goldschmidt AG) |
| 0.6 part by weight | activator Desmorapid ® PV (Bayer AG) |
| 1.8 parts by weight | activator Desmorapid ® DB (Bayer AG) |
| 0.21 part by weight | activator Dabco 33 LV (Air Products) |
| 1.05 parts by weight | water. |

Component B:

Desmodur ® 44V10L (Bayer AG)
Polyisocyanate mixture of the diphenylmethane group, prepared by
phosgenation of an aniline/formaldehyde condensation product;
NCO content: 31.5 wt. %, viscosity (at 25° C.): 100 mPa · s.

Components A and B were made to react in a weight ratio of 100:148 by means of stirrers and compressed to an apparent density of 250 kg/m³ in a closed mold. The free apparent density of the foam was 100 kg/m³.

### Example 2 (Comparison)

Formulation for rigid PUR foam:

Component A:

| | |
|---|---|
| 45.0 parts by weight | sucrose, propylene glycol-started polyether having a |
| | molecular weight of 600 g/mol. (OH number: 450) |
| | based on 1,2-propylene oxide |
| 35.0 parts by weight | sucrose, ethylene glycol-started polyether having a |
| | molecular weight of 360 g/mol. (OH number: 440) |
| | based on 1,2-propylene oxide |
| 15.0 parts by weight | trimethylolpropane-started polyether having a |
| | molecular. weight of 160 g/mol. (OH number: 1030) |
| | based on 1,2-propylene oxide |
| 1 part by weight | stabilizer B 8411 (Goldschmidt AG) |
| 0.6 part by weight | activator Desmorapid ® PV (Bayer AG) |
| 1.8 parts by weight | activator Desmorapid ® DB (Bayer AG) |
| 0.21 part by weight | activator Dabco 33 LV (Air Products) |
| 1.95 parts by weight | water |
| 6.0 parts by weight | Baylith ® L (zeolite from UOP) |

Component B:

Desmodur ® 44V10L (Bayer AG)

Polyisocyanate mixture of the diphenylmethane group, prepared by phosgenation of an aniline/formaldehyde condensation product; NCO content: 31.5 wt. %, viscosity (at 25° C.): 100 mPa·s.

Components A and B were made to react in a weight ratio of 100:137 by means of stirrers and compressed to an apparent density of 250 kg/m³ in a closed mold. The free apparent density of the foam was 100 kg/m³.

### Example 3

### According to the Invention

Formulation for rigid PUR foam:

Component A:

| | |
|---|---|
| 45.0 parts by weight | sucrose, propylene glycol-started polyether having a |
| | molecular weight of 600 g/mol. (OH number: 450) |
| | based on 1,2-propylene oxide |
| 35.0 parts by weight | sucrose, ethylene glycol-started polyether having a |
| | molecular weight of 360 g/mol. (OH number: 440) |
| | based on 1,2-propylene oxide |
| 15.0 parts by weight | trimethylolpropane-started polyether having a |
| | molecular weight of 160 g/mol. (OH number: 1030) |
| | based on 1,2-propylene oxide |
| 1 part by weight | stabilizer B 8411 (Goldschmidt AG) |
| 0.6 part by weight | activator Desmorapid ® PV (Bayer AG) |
| 1.8 parts by weight | activator Desmorapid ® DB (Bayer AG) |
| 0.21 part by weight | activator Dabco 33 LV (Air Products) |
| 1.95 parts by weight | water |

Component B:

Desmodur ® 44V10L (Bayer AG)

Polyisocyanate mixture of the diphenylmethane group, prepared by phosgenation of an aniline/formaldehyde condensation product; NCO content: 31.5 wt. %, viscosity (at 25° C.): 100 mPa·s, and 4 wt. % Baylithe L (zeolite from UOP).

Components A and B were made to react in a weight ratio of 100:151 by means of stirrers and compressed to an apparent density of 250 kg/m³ in a closed mold. The free apparent density of the foam was 100 kg/m³.

In all three examples, the free apparent density was 100 kg/m³ and the final apparent density was 250 kg/m³; the compression factor was 2.5. The table below shows the Shore hardnesses, which are a measure of the markedness of the integral structure.

| | Ex. 1 | Ex. 2 | Ex. 3 |
|---|---|---|---|
| | (comp.) | (comp.) | (invention) |
| Shore D | 33 | 38 | 44 |

By means of the process according to the invention, it is possible to achieve surface hardnesses which can otherwise be achieved only using physical blowing agents. However, these are either prohibited (HCFC) or flammable (pentane). The use of zeolites in the isocyanate component further increases the Shore hardness considerably in comparison with their use in the polyol formulation. Sheets of various apparent densities were manufactured using the formulation of Example 3 and the formulation of Example 1. The densities and hardness values for those sheets were as follows:

| | Apparent density (kg/m³) | | | | | |
|---|---|---|---|---|---|---|
| | 180 | 200 | 225 | 250 | 275 | 350 |
| Shore D (formulation 1) | 24 | 27 | 30 | 33 | 36 | 42 |
| Shore D (formulation 3) | 32 | 35 | 39 | 44 | 48 | 56 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of polyurethane integral skin foams comprising
(1) preparing a polyol formulation (A) comprising
a) at least one polyol component having a OH number of from 20 to 1050 and a functionality of from 2 to 6, or a mixture of polyol components having a mathematically ascertained mean OH number of from 250 to 650 and a mathematically ascertained mean functionality of from 2.5 to 5,
b) optionally, one or more chain extenders and/or crosslinkers,
c) optionally, one or more activators,
d) water and
e) optionally, one or more additives and auxiliary substances, and
(2) reacting formulation (A) with an isocyanate component (B) comprising
f) one or more organic and/or modified organic polyisocyanates and/or polyisocyanate pre-polymers and
g) one or more inorganic zeolites.

2. The process of claim 1 in which the polyol a) has a functionality of from 2 to 5.

3. The process of claim 1 in which the polyol a) has an OH number of from 200 to 900.

4. The process of claim 1 in which a) is a mixture of polyols.

5. The process of claim 4 in which the mean OH number of a) is from 350 to 500.

6. The process of claim 4 in which the mean functionality of a) is from 3 to 4.5.

7. The process of claim 1 in g) is a zeolite of the faujasite type.
